(19) United States
(12) Patent Application Publication
(10) Pub. No.: US 2022/0180559 A1
(43) Pub. Date: Jun. 9, 2022

(54) On-Site Calibration for Mobile Automation Apparatus

(71) Applicant: ZEBRA TECHNOLOGIES CORPORATION, Lincolnshire, IL (US)

(72) Inventor: Tiberiu Visan, Burlington (CA)

(21) Appl. No.: 17/113,741

(22) Filed: Dec. 7, 2020

(51) Int. Cl. G06T 7/80; G05D 1/02; G06T 7/73

(52) U.S. Cl. CPC G06T 7/80; G05D 1/0234; G05D 2201/0207; G06T 7/74; G05D 1/0246

(57) ABSTRACT

A calibration method for a mobile automation apparatus includes: navigating the apparatus to a calibration location containing a reflector; controlling a camera of the apparatus to capture an image depicting a first set of markers affixed to the reflector in first predetermined positions defining a reflector frame of reference, and virtual images of a second set of markers mounted on a chassis of the apparatus in second predetermined positions defining a chassis frame of reference, and reflected in the reflector; detecting respective image positions of each marker from the first and second sets of markers; based on the image positions of the first and second set of markers, the first predetermined positions, and the second predetermined positions, determining calibration parameters configured to convert between coordinates in a camera frame of reference and coordinates in the chassis frame of reference; and updating calibration data of the camera with the calibration parameters.

### BACKGROUND

Calibration of cameras affixed to mobile platforms may enable navigational functions and/or image-processing functions by such a platform. Calibrating cameras may, however, involve the deployment of complex calibration devices manipulated by trained staff, separate from the platform itself.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a schematic of a mobile automation system.

FIG. 2 is a side view of a mobile automation apparatus in the system of FIG. 1.

FIG. 3 is an isometric view of the mobile automation apparatus in the system of FIG. 1, viewed from below.

FIG. 4 is a diagram of a reflector employed for calibrating the cameras of the mobile automation apparatus.

FIG. 5 is a diagram illustrating certain internal components of the mobile automation apparatus.

FIG. 6 is a calibration method for the mobile automation apparatus.

FIG. 7 is a diagram illustrating an example performance of blocks 605-615 of the method of FIG. 6.

FIG. 8 is a diagram of an image captured at block 620 of the method of FIG. 6, and marker positions derived therefrom.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a calibration method for a mobile automation apparatus, the method comprising: navigating the mobile automation apparatus to a calibration location containing a reflector; controlling a camera of the mobile automation apparatus to capture an image depicting (i) a first set of markers affixed to the reflector in first predetermined positions defining a reflector frame of reference, and (ii) a second set of markers mounted on a chassis of the mobile automation apparatus in second predetermined positions defining a chassis frame of reference; detecting respective image positions of each marker from the first set of markers and the second set of markers; based on (i) the image positions of the first and second set of markers, (ii) the first predetermined positions, and (iii) the second predetermined positions, determining calibration parameters configured to convert between coordinates in a camera frame of reference and coordinates in the chassis frame of reference; and updating calibration data of the camera with the calibration parameters.

Additional examples disclosed herein are directed to a mobile automation apparatus, comprising: a chassis; a camera supported by the chassis; a plurality of markers affixed to the chassis in predetermined positions defining a chassis frame of reference; and a processor configured to: responsive to arrival of the mobile automation apparatus at a calibration location containing a reflector, control the camera to capture an image depicting (i) a first set of markers affixed to the reflector in first predetermined positions defining a reflector frame of reference, and (ii) a subset of the markers affixed to the chassis; detect respective image positions of each marker from the first set of markers and the second set of markers; based on (i) the image positions of the first and second set of markers, (ii) the first predetermined positions, and (iii) the second predetermined positions, determine calibration parameters configured to convert between coordinates in a camera frame of reference and coordinates in the chassis frame of reference; and update calibration data of the camera with the calibration parameters.

Further examples disclosed herein are directed to a non-transitory computer-readable medium storing computer-readable instructions for calibration of a mobile automation apparatus, the instructions executable by a processor to: navigate the mobile automation apparatus to a calibration location containing a reflector; control a camera of the mobile automation apparatus to capture an image depicting (i) a first set of markers affixed to the reflector in first predetermined positions defining a reflector frame of reference, and (ii) a second set of markers mounted on a chassis of the mobile automation apparatus in second predetermined positions defining a chassis frame of reference; detect respective image positions of each marker from the first set of markers and the second set of markers; based on (i) the image positions of the first and second set of markers, (ii) the first predetermined positions, and (iii) the second predetermined positions, determine calibration parameters configured to convert between coordinates in a camera frame of reference and coordinates in the chassis frame of reference; and update calibration data of the camera with the calibration parameters.

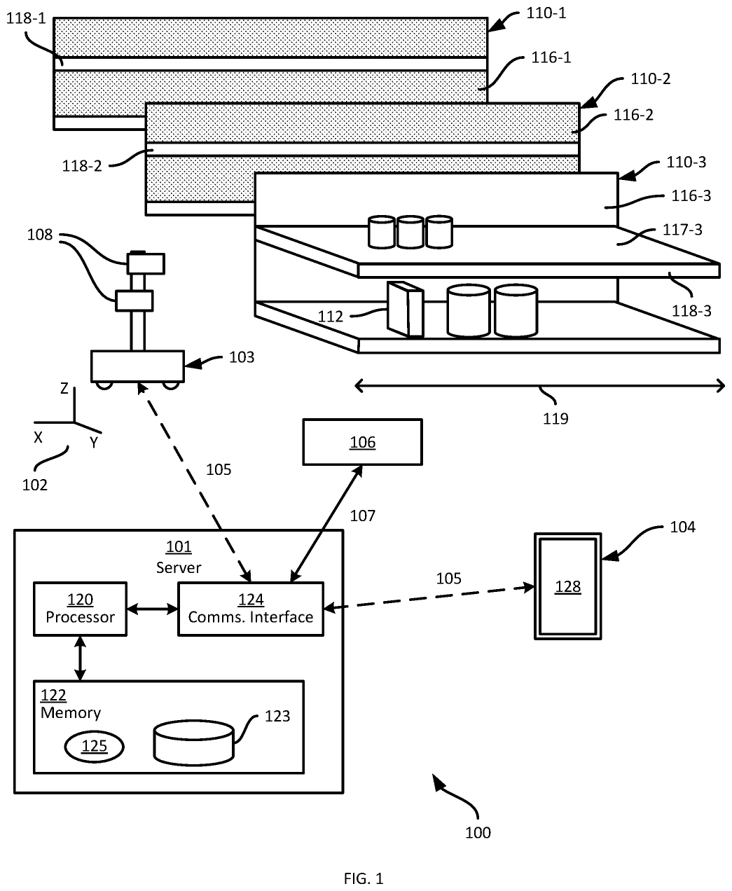

FIG. 1 depicts a mobile automation system 100 in accordance with the teachings of this disclosure. The system 100 includes a server 101 in communication with at least one mobile automation apparatus 103 (also referred to herein simply as the apparatus 103) and at least one client computing device 104 via communication links 105, illustrated in the present example as including wireless links. In the present example, the links 105 are provided by a wireless local area network (WLAN) deployed via one or more access points (not shown). In other examples, the server 101, the client device 104, or both, are located remotely (i.e. outside the environment in which the apparatus 103 is deployed), and the links 105 therefore include wide-area networks such as the Internet, mobile networks, and the like. The system 100 also includes a dock 106 for the apparatus 103 in the present example. The dock 106 is in communication with the server 101 via a link 107 that in the present example is a wired link. In other examples, however, the link 107 is a wireless link.

The client computing device 104 is illustrated in FIG. 1 as a mobile computing device, such as a tablet, smart phone or the like. In other examples, the client device 104 is implemented as another type of computing device, such as a desktop computer, a laptop computer, another server, a kiosk, a monitor, and the like. The system 100 can include a plurality of client devices 104 in communication with the server 101 via respective links 105.

The system 100 is deployed, in the illustrated example, in a retail facility including a plurality of support structures such as shelf modules 110-1, 110-2, 110-3 and so on (collectively referred to as shelf modules 110 or shelves 110, and generically referred to as a shelf module 110 or shelf 110—this nomenclature is also employed for other elements discussed herein). Each shelf module 110 supports a plurality of products 112 (also referred to as items), which may also be referred to as items. Each shelf module 110 includes a shelf back 116-1, 116-2, 116-3 and a support surface (e.g. support surface 117-3 as illustrated in FIG. 1) extending from the shelf back 116 to a shelf edge 118-1, 118-2, 118-3. A variety of other support structures may also be present in the facility, such as pegboards, tables, and the like.

The shelf modules 110 (also referred to as sub-regions of the facility) are typically arranged in a plurality of aisles (also referred to as regions of the facility), each of which includes a plurality of modules 110 aligned end-to-end. In such arrangements, the shelf edges 118 face into the aisles, through which customers in the retail facility, as well as the apparatus 103, may travel. As will be apparent from FIG. 1, the term “shelf edge” 118 as employed herein, which may also be referred to as the edge of a support surface (e.g., the support surfaces 117) refers to a surface bounded by adjacent surfaces having different angles of inclination. In the example illustrated in FIG. 1, the shelf edge 118-3 is at an angle of about ninety degrees relative to the support surface 117-3 and to the underside (not shown) of the support surface 117-3. In other examples, the angles between the shelf edge 118-3 and the adjacent surfaces, such as the support surface 117-3, is more or less than ninety degrees.

The apparatus 103 is equipped with a plurality of navigation and data capture sensors 108, such as image sensors (e.g. one or more digital cameras) and depth sensors (e.g. one or more Light Detection and Ranging (LIDAR) sensors, one or more depth cameras employing structured light patterns, such as infrared light, or the like). The apparatus 103 is deployed within the retail facility and, via communication with the server 101 and use of the sensors 108, navigates autonomously or partially autonomously along a length 119 of at least a portion of the shelves 110.

While navigating among the shelves 110, the apparatus 103 can capture images, depth measurements and the like, representing the shelves 110 and the items 112 supported by the shelves 110 (generally referred to as shelf data or captured data). Navigation may be performed according to a frame of reference 102 established within the retail facility. The apparatus 103 therefore tracks its pose (i.e. location and orientation) in the frame of reference 102. The tracked posed may be employed for navigation, and/or to permit data captured by the apparatus 103 to be registered to the frame of reference 102 for subsequent processing.

As will be described in greater detail herein, the apparatus 103 also implements certain functions to calibrate at least some of the sensors 108. Such calibration may enable the apparatus 103 to maintain accurate pose tracking in the frame of reference 102. Calibration may also enable the apparatus 103 and/or the server 101 to accurately combine images captured by separate cameras of the apparatus 103.

The server 101 includes a special purpose controller, such as a processor 120, specifically designed to control and/or assist the mobile automation apparatus 103 to navigate the environment and to capture data. The processor 120 is interconnected with a non-transitory computer readable storage medium, such as a memory 122, having stored thereon computer readable instructions for performing various functionality, including control of the apparatus 103 to navigate the modules 110 and capture shelf data, as well as post-processing of the shelf data. The memory 122 can also store data for use in the above-mentioned control of the apparatus 103 and post-processing of captured data, such as a repository 123. The repository 123 can contain, for example, a map of the facility, operational constraints for use in controlling the apparatus 103, the image and/or depth data captured by the apparatus 103, and the like.

The memory 122 includes a combination of volatile memory (e.g. Random Access Memory or RAM) and non-volatile memory (e.g. read only memory or ROM, Electrically Erasable Programmable Read Only Memory or EEPROM, flash memory). The processor 120 and the memory 122 each comprise one or more integrated circuits. In some embodiments, the processor 120 is implemented as one or more central processing units (CPUs) and/or graphics processing units (GPUs).

The server 101 also includes a communications interface 124 interconnected with the processor 120. The communications interface 124 includes suitable hardware (e.g. transmitters, receivers, network interface controllers and the like) allowing the server 101 to communicate with other computing devices—particularly the apparatus 103, the client device 104 and the dock 106—via the links 105 and 107. The links 105 and 107 may be direct links, or links that traverse one or more networks, including both local and wide-area networks. The specific components of the communications interface 124 are selected based on the type of network or other links that the server 101 is required to communicate over. In the present example, as noted earlier, a wireless local-area network is implemented within the retail facility via the deployment of one or more wireless access points. The links 105 therefore include either or both wireless links between the apparatus 103 and the mobile device 104 and the above-mentioned access points, and a wired link (e.g. an Ethernet-based link) between the server 101 and the access point.

The processor 120 can therefore obtain data captured by the apparatus 103 via the communications interface 124 for storage (e.g. in the repository 123) and subsequent processing (e.g. to detect objects such as shelved products 112 in the captured data, and detect status information corresponding to the objects). The server 101 maintains, in the memory 122, an application 125 executable by the processor 120 to perform such subsequent processing.

The server 101 may also transmit status notifications (e.g. notifications indicating that products are out-of-stock, in low stock or misplaced) to the client device 104 responsive to the determination of product status data. The client device 104 includes one or more controllers (e.g. central processing units (CPUs) and/or field-programmable gate arrays (FPGAs) and the like) configured to process notifications and other information received from the server 101. For example, the client device 104 includes a display 128 controllable to present information received from the server 101.

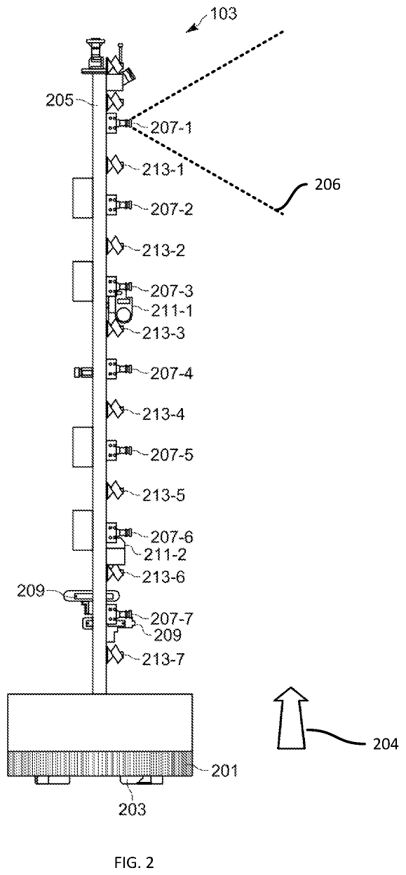

Turning now to FIG. 2, the mobile automation apparatus 103 is shown in greater detail. The apparatus 103 includes a chassis, a lower portion 201 of which is illustrated in FIG. 2. The remainder of the chassis is omitted in FIG. 2 to illustrate the various sensors supported within the chassis. The lower portion 201 contains a locomotive assembly 203 (e.g. one or more electrical motors driving wheels, tracks or the like). The apparatus 103 further includes a sensor mast 205 supported on the lower portion 201 of the chassis and, in the present example, extending upwards (e.g., substantially vertically). The mast 205 supports the sensors 108 mentioned earlier. In particular, the sensors 108 include at least one imaging sensor 207, such as a digital camera. In the present example, the mast 205 supports seven digital cameras 207-1 through 207-7 oriented to face the shelves 110. That is, in the illustrated orientation, the apparatus 103 travels in a direction 204 and fields of view (FOV) of the cameras 207 face towards the right, substantially perpendicular to the direction 204, as shown by an example FOV 206 of the camera 207-1.

The mast 205 also supports at least one depth sensor 209, such as a 3D digital camera capable of capturing both depth data and image data. The apparatus 103 also includes additional depth sensors, such as LIDAR sensors 211. In the present example, the mast 205 supports two LIDAR sensors 211-1 and 211-2. As shown in FIG. 2, the cameras 207 and the LIDAR sensors 211 are arranged on one side of the mast 205, while the depth sensor 209 is arranged on a front of the mast 205. That is, the depth sensor 209 is forward-facing (i.e. captures data in the direction of travel 204 of the apparatus 103), while the cameras 207 and LIDAR sensors 211 are side-facing (i.e. capture data alongside the apparatus 103, in a direction perpendicular to the direction of travel). In other examples, the apparatus 103 includes additional sensors, such as one or more RFID readers, temperature sensors, and the like.

The mast 205 also supports a plurality of illumination assemblies 213, configured to illuminate the fields of view of the cameras 207. The cameras 207 and lidars 211 are oriented on the mast 205 such that the fields of view of the sensors each face a shelf 110 along the length 119 of which the apparatus 103 is traveling.

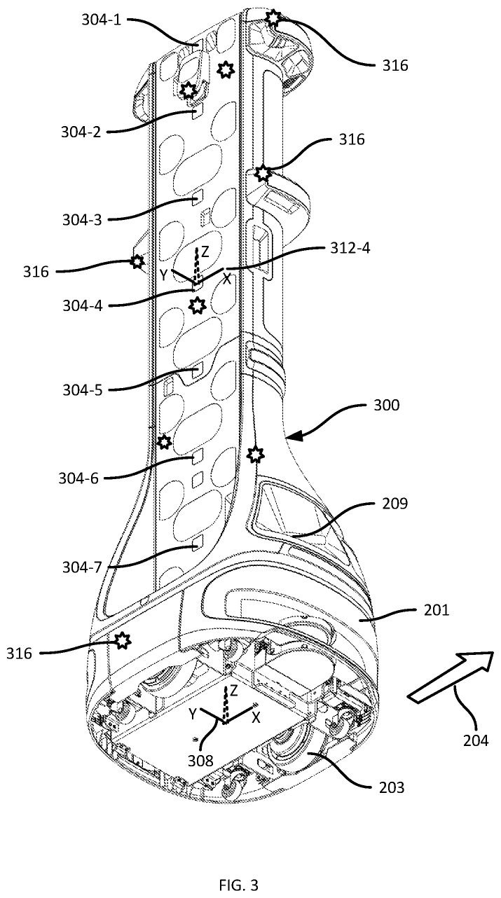

Turning to FIG. 3, the apparatus 103 is shown with a complete chassis 300 enclosing the mast 205 and sensors mentioned above. The chassis 300 includes openings for various components, such as the illumination assemblies 213 and the image and depth sensors. For example, the chassis 300 as shown in FIG. 3 may be generally opaque, but includes respective apertures 304-1, 304-2, 304-3, 304-4, 304-5, 304-6, and 304-7 corresponding to the cameras 207 shown in FIG. 2. Other apertures may be provided for other components shown in FIG. 2.

The apparatus 103 defines a local frame of reference 308, also referred to as a chassis frame of reference 308, e.g. with an origin at the center of a base of the apparatus 103, as shown in FIG. 3. That is, X and Y axes of the frame of reference 308 may be parallel to the horizontal planar surfaces over which the apparatus 103 travels (e.g. the floor of the above-mentioned retail facility), while the Z axis may be substantially vertical, and in some examples may be coaxial with the mast 205. The current relationship between the frame of reference 308 and the frame of reference 102 shown in FIG. 1 defines the current pose of the apparatus 103.

In addition, each camera 207 defines a local frame of reference 312, also referred to as a camera frame of reference 312. An example frame of reference 312-4 is shown in FIG. 3, corresponding to the camera 207-4 (behind the aperture 304-4). The remaining cameras 207 also have respective camera frames of reference 312, not shown in FIG. 3. The relationship between the chassis frame of reference 308 and each camera frame of reference 312 is ideally fixed, and forms a portion of a set of calibration data for the corresponding camera 207. As will be apparent to those skilled in the art, the above-mentioned relationship may be referred to as extrinsic calibration data, defining the pose of the camera 207 relative to the structure supporting the camera 207. The calibration data also includes intrinsic parameters, such as focal length and other geometric properties of the camera 207, such as the coordinates of the center of the camera sensor. The apparatus 103 may store such calibration data, for use during navigational and data capture activities.

Although the relationship between the chassis frame of reference 308 and each camera frame of reference 312 is ideally fixed, under certain conditions, such relationships may change. For example, when a camera 207 is removed for servicing, the camera 207 may not be replaced on the mast 205 with exactly the same pose relative to the chassis frame of reference 308 as previously. In other words, the previously stored calibration data for the camera 207 may no longer be accurate. As a result, navigational functions such as pose tracking by the apparatus 103, and/or data capture functions such as stitching together images from multiple cameras 207 to form a combined image, may suffer from reduced accuracy until the relevant camera 207 is recalibrated.

Recalibration generally includes using the target camera (i.e. the camera 207 to be recalibrated) to capture an image of a calibration device. Calibration devices can include fiducial markers with predefined relative positions, patterns detectable from captured images, or combinations thereof. By placing the apparatus 103 at a known position relative to the calibration device, and detecting the markers and/or patterns in the captured image, the pose of the camera 207 relative to the chassis frame of reference 308 can be determined and stored as updated calibration data.

The above-mentioned calibration devices can be cumbersome and complex, however, and this calibration process may require trained staff to perform. The size and complexity of the calibration device, along with a need for the calibration device to maintain precisely defined geometric properties, make deploying calibration devices to each facility where an apparatus 103 is deployed costly and time-consuming. Further, deploying trained calibration staff to each facility may also be logistically challenging. The apparatus 103 may be transported to a central facility for calibration, but the size and complexity of the apparatus 103 itself (which may have a height of about 2 m) renders transport difficult, and risks damage to the apparatus 103.

The apparatus 103 therefore includes additional features enabling on-site calibration of the cameras 207, while reducing the reliance of the calibration process on complex calibration devices and trained staff.

In particular, the apparatus 103 also includes a plurality of markers 316, also referred to herein as chassis markers 316, affixed to the chassis 300 in various positions. The position of each chassis marker 316 is predetermined (e.g. when the apparatus 103 is manufactured) according to the chassis frame of reference 308 and stored, e.g. in a memory of the apparatus 103 and/or at the server 101.

The chassis markers 316 are, in the present example, fiducial markers including reflective material (e.g. retroreflectors). The chassis markers 316 can reflect visible light, infrared light, or a combination thereof, depending on the capabilities of the cameras 207. The chassis markers 316 may be applied to the chassis 300, e.g. as stickers, paint or the like, or may be embedded or otherwise integrated with the chassis 300. In some examples, the chassis markers 316 are placed at different depths (i.e. at different positions along the Y axis of the frame of reference 308).

To calibrate a camera 207, as will be discussed in greater detail herein, the relevant camera 207 is controlled to capture an image that contains at least a set of the chassis markers 316. The number of chassis markers 316 affixed to the chassis 300 is therefore selected to enable each camera 207 to capture images containing a sufficient set of the markers 316 for calibration. For example, the apparatus 103 may include enough markers 316 for each camera 207 to capture a set of at least twelve markers 316.

As will be apparent, the chassis markers 316 are not directly visible to the cameras 207, as some or all of the markers 316 lie outside (and often behind) the FOVs of the cameras 207. The calibration process implemented by the apparatus 103 therefore also makes use of a reflector, such as a mirror, with additional features to be discussed below.

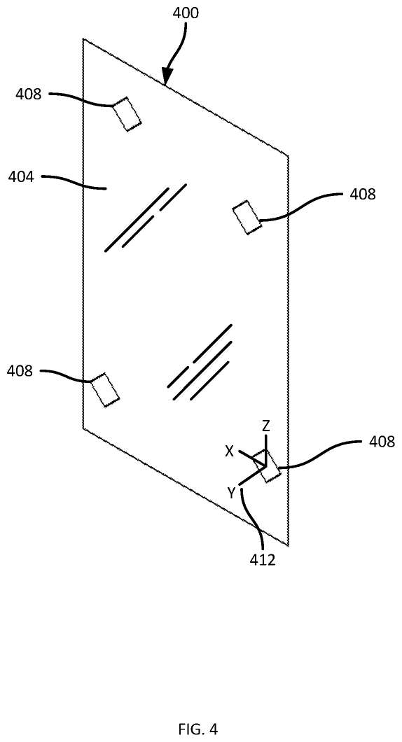

Turning to FIG. 4, a reflector 400 for use in calibrating one or more of the cameras 207 of the apparatus 103 is shown. The reflector 400 includes a flat (i.e. planar) reflective surface 404, e.g. provided by a mirror. The reflector 400 can also include a fixed or movable support structure (not shown) for the reflective surface, or can be mounted to a wall, or the like. The reflector 400 enables the cameras 207, when the apparatus 103 is positioned to substantially face the reflector 400, to capture images that depict the apparatus 103 itself, and therefore at least some of the chassis markers 316.

As will be apparent, the perceived positions of the chassis markers 316 by the cameras 207 depend on the position and orientation of the apparatus 103 (i.e. the chassis frame of reference 308) relative to the reflector 400. To mitigate the need for precise positioning of the apparatus 103 at a predefined pose relative to the reflector 400, the reflector 400 also includes a plurality of markers 408, also referred to herein as reflector markers 408. The reflector markers 408 enable the apparatus 103, as described below, to determine the pose of the apparatus 103 relative to the reflector 400, and to employ that determined pose to then determine the pose of the apparatus 103 relative to the camera targeted for calibration. The number of reflector markers 408 is therefore selected to enable each camera 207 to capture an image of the reflector 400 that contains a sufficient number of markers 408 to accurately determine the pose of the apparatus 103 relative to the reflector 400. In the present example, the reflector 400 includes four markers 408, and it is assumed that all four markers 408 are visible to each camera 207. In other examples, the calibration process described herein may be feasible with as few as three markers 408.

The reflector markers 408, in this example, are distinguished from the chassis markers 316 by at least one visual attribute detectable by the cameras 207. For example, the reflector markers 408 can be of a different color than the chassis markers 316. In other examples, as illustrated in FIGS. 3 and 4, the chassis markers 316 have a first shape (e.g. a seven-point star), while the reflector markers 408 have a second shape (e.g. a diamond). In other examples, either or both of the markers 316 and 408 can include visual labels (e.g. barcodes or other machine-readable indicia). Combinations of the above-mentioned visual attributes may also be used to distinguish the reflector markers 408 from the chassis markers 316.

The reflector markers 408 also have predetermined, fixed positions on the reflector 400. The positions of the reflector markers 408 are defined according to a reflector frame of reference 412. In the illustrated example, the reflector frame of reference 412 has an origin indicated by on of the reflector markers 408, and an XZ plane containing the reflective surface 404.

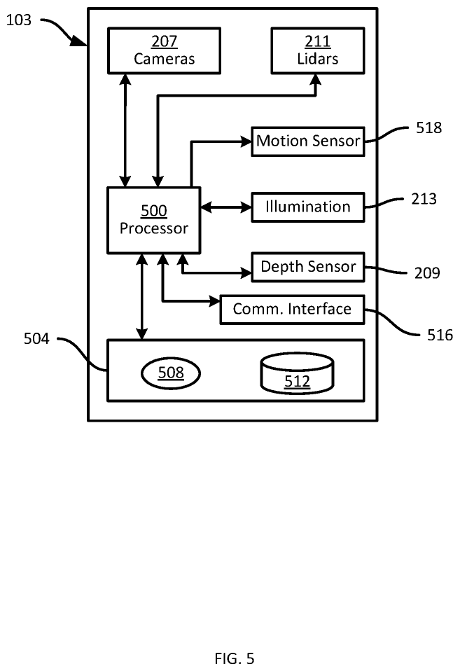

Before discussing the calibration procedure itself, certain internal components of the apparatus 103 will be described, with reference to FIG. 5. In addition to the cameras 207, depth sensor 209, lidars 211, and illumination assemblies 213 mentioned above, the apparatus 103 includes a special-purpose controller, such as a processor 500, interconnected with a non-transitory computer readable storage medium, such as a memory 504. The memory 504 includes a suitable combination of volatile memory (e.g. Random Access Memory or RAM) and non-volatile memory (e.g. read only memory or ROM, Electrically Erasable Programmable Read Only Memory or EEPROM, flash memory). The processor 500 and the memory 504 each comprise one or more integrated circuits.

The memory 504 stores computer readable instructions for execution by the processor 500. In particular, the memory 504 stores a calibration application 508 which, when executed by the processor 500, configures the processor 500 to perform various actions to calibrate one or more of the cameras 207. The processor 500, when so configured by the execution of the application 508, may also be referred to as a calibration controller 500. Those skilled in the art will appreciate that the functionality implemented by the processor 500 via the execution of the application 508 may also be implemented by one or more specially designed hardware and firmware components, such as FPGAs, ASICs and the like in other embodiments.

The memory 504 may also store a repository 512 containing, for example, a map of the environment in which the apparatus 103 operates, as well as calibration data corresponding to each of the cameras 207. The calibration data can include, for example, intrinsic and extrinsic parameters for each camera 207, as well as the predetermined positions of the chassis markers 316 according to the chassis frame of reference 308, and the predetermined positions of the reflector markers 408 according to the reflector frame of reference 412.

The apparatus 103 also includes a communications interface 516 enabling the apparatus 103 to communicate with the server 101 (e.g. via the link 105 or via the dock 106 and the link 107), for example to receive instructions to navigate to specified locations and initiate data capture operations, a calibration procedure, or the like.

In addition to the sensors mentioned earlier, the apparatus 103 can also include a motion sensor 518, such as one or more wheel odometers coupled to the locomotive assembly 203. The motion sensor 518 can also include, in addition to or instead of the above-mentioned wheel odometer(s), an inertial measurement unit (IMU) configured to measure acceleration along a plurality of axes.

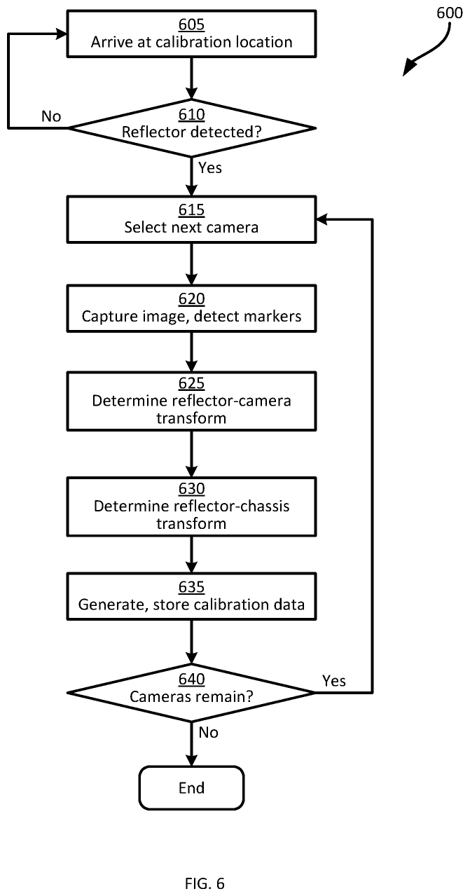

Turning now to FIG. 6, the functionality implemented by the apparatus 103 to calibrate one or more cameras 207 will be discussed in greater detail. FIG. 6 illustrates a calibration method 600, which will be discussed below in conjunction with its performance by the apparatus 103.

At block 605, the apparatus 103 is placed at a calibration location prior to beginning the calibration process. Placing the apparatus 103 at the calibration location can take a variety of forms. In some examples, the calibration location is a particular, fixed location within the facility, e.g. where the reflector 400 is mounted. In some facilities, multiple reflectors 400, each with the same arrangement of markers 408, can be deployed at respective calibration locations.

In such examples, the apparatus 103 can be sent a navigational command, e.g. from the server 101, to travel to the calibration location. The calibration location can be stored in the map mentioned above, and the apparatus 103 may therefore be configured to autonomously navigate to the relevant location in response to the navigational command, by sensing its surroundings to track its pose relative to the frame of reference 102 and controlling the locomotive assembly 203. In other examples, the apparatus 103 may be piloted, e.g. by a human operator issuing motor commands to the apparatus 103. In further examples, the reflector 400 may be movable, and the performance of block 605 may involve transporting the reflector 400 to a current location of the apparatus 103.

Arrival of the apparatus 103 at the calibration location may therefore be detected autonomously by the apparatus 103 (e.g. if the apparatus 103 navigated to the calibration location), or signaled to the apparatus 103 by a command instructing the apparatus 103 to begin calibration (e.g. if the apparatus 103 was piloted, or if the reflector 400 was transported to the vicinity of the apparatus 103).

At block 610, the apparatus 103 (via execution of the application 508) can be configured to verify that the reflector 400 is within the FOVs 206 of the cameras 207. The apparatus 103 may be configured, in some examples, to capture an image with at least one of the cameras 207, and to detect the reflector markers 408 in the image. When the number of the markers 408 detected satisfies a threshold (e.g. four, although three may also be used in other examples, and greater thresholds than four may also be used), the determination at block 610 is affirmative. In some examples, the apparatus 103 may also determine whether the detected markers 408 have positions in the captured image that are separated by at least a threshold pixel distance, indicating that the apparatus 103 is positioned with the optical axes of the cameras 207 sufficiently close to being perpendicular to the reflective surface 404. As will be apparent, if the apparatus 103 is sharply angled relative to the reflective surface 404, the apparatus 103 itself may not be adequately reflected in the reflective surface 404. Under such conditions, the markers 408 would appear close together in the captured image.

When the determination at block 610 is negative, the apparatus 103 can reposition itself, e.g. by rotating on the spot, by repeating a pose determination operation in the event that localization accuracy has degraded, or the like. The apparatus 103 can then repeat the determination at block 610, after repositioning or travelling to an updated location as needed.

At block 615, the apparatus 103 is configured to select the next camera 207 for calibration. The calibration process can be performed for a specific camera, e.g. based on an instruction (such as the above-mentioned navigational command) received by the apparatus 103. In other examples, the apparatus 103 may perform the method 600 to calibrate all the cameras 207, in which case the process below may be repeated sequentially for each camera 207, or in parallel for all cameras 207 substantially simultaneously. In any event, the process set out below is performed for each camera 207 to be calibrated.

At block 620, the processor 500 is configured to control the selected camera (e.g. the camera 207-4 in this example) to capture an image. The processor 500 is further configured to detect the reflector markers 408 and the chassis markers 316 in the captured image. As will be apparent, the set of chassis markers 316 visible in the captured image may not include every chassis marker 316.

Detection of the markers 316 and 408 can be performed by searching the captured image for regions of elevated intensity, for example in the case of retroreflector markers, which generate bright spots in images. The processor 500, in other words, can identify bright regions in each image (e.g. with a brightness exceeding a threshold), and determine a location, in each image, of a center of each bright region. The detection of markers can also include performing edge detection, color detection, or the like, to distinguish between the reflector markers 408 and the chassis markers 316.

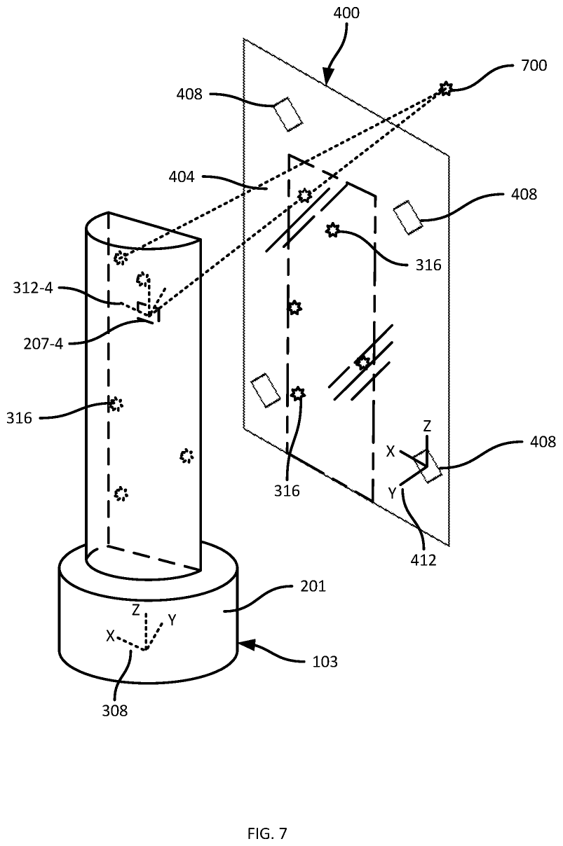

Turning to FIG. 7, the apparatus 103 and the reflector 400 are shown in close enough proximity for at least a portion of the chassis 300 to be reflected in the reflective surface 404 so as to be visible to the camera 207-4. Reflections of the chassis markers 316 are also visible in the reflective surface 404. As will be apparent to those skilled in the art, the cameras 207, e.g. the camera 207-4 as shown in FIG. 7, perceive the reflections as portions of a virtual image behind the reflective surface 404. For example, a virtual marker 700 is shown behind the plane of the reflective surface 404, relative to the apparatus 103, indicating the perceived position of the corresponding marker 316 to the camera 207-4.

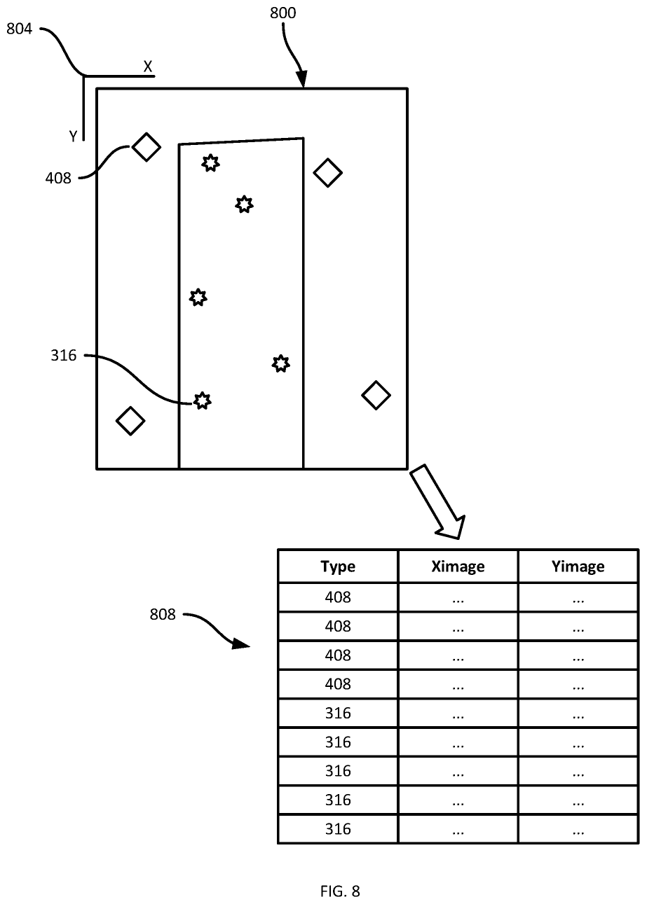

FIG. 8 illustrates an example image 800 captured by the camera 207-4, in which the markers 316 and 408 are visible. As a result of the performance of block 320, the processor 500 also obtains a set of marker positions 808 in the image 800. The set of marker positions 808 distinguishes between marker types, and includes the pixel coordinates of each detected marker, according to a two-dimensional image frame of reference 804 (which is distinct from the three-dimensional camera frame of reference 312).

As noted earlier, the positions of each chassis marker 316 in the chassis frame of reference 308 is stored in the memory 504, and the position of each reflector marker 408 in the reflector frame of reference 412 is also stored in the memory 504. The pose of the camera 207-4 in the chassis frame of reference 308 cannot be determined directly from the positions of the markers 316 in the image 800 and the previously defined positions of the markers 316 in the frame of reference 308, because the appearance of the markers 316 in the image 800 is modified by the presence of the reflector 400.

More specifically, the perception of the chassis markers 316 by the camera 207-4 (and indeed, any of the cameras 207) is defined by a chain of transformations or transforms, which may also be referred to as sets of calibration parameters. Each transform is configured to convert between coordinates in one frame of reference and coordinates in another frame of reference. That chain of transformations includes:
a. the camera intrinsic parameters (which affect how any object external to the camera 207 is captured on the sensor of the camera 207),
b. the position of the reflector 400 relative to the camera 207-4,
c. a reflective transformation resulting from the fact that the markers 316 are observed in reflection rather than directly, and
d. the position of the reflector 400 relative to the chassis 300.

The camera intrinsic parameters are assumed to be known. Returning to FIG. 6, the apparatus 103 is configured to determine certain intermediate information prior to generating updated calibration data in the form of an updated pose of the camera 207-4 relative to the chassis frame of reference 308. The intermediate information includes the transformations b, c, and d mentioned above.

In particular, at block 625 the processor 500 is configured to determine a transform between the camera frame of reference 312 and the reflector frame of reference 412. The transform, e.g. a matrix of coefficients that can be applied to coordinates in one frame of reference to obtain coordinates of the same point in space in the other frame of reference, defines the position of the reflector 400 and the camera 207-4 relative to one other. That is, at block 625 the apparatus 103 determines the transform listed under “b” above.

Determining the transform at block 625 can be accomplished using a suitable solution for a perspective-n-point (PnP) problem, based on the image positions of the markers 408, as well as the predefined positions of the markers 408 in the reflector frame of reference 412. As will be apparent to those skilled in the art, various solutions are available for P4P problems, in which positional data is available for four markers 408 are available. The performance of block 625 may also be accomplished when three markers 408 are visible, as various solutions also exist for P3P problems. The transform determined at block 625 is a matrix “M” defining a rotation and a translation between the frames of reference 312 and 412.

At block 625, the processor 500 may also determine a reflective transformation resulting from the fact that the markers 316 are observed in reflection rather than directly, as referenced above under “c”. The reflective transformation is a matrix “H” defining a reflection of the input point(s) about a plane, and may also be referred to as a Householder transform. The coefficients of the reflective transformation are based on an equation of the plane about which the reflection is taken. In this example, that plane is the plane containing the reflective surface 404, i.e. the XZ plane of the frame of reference 412. To generate the reflective transform, the processor 500 can therefore be configured to determine an equation for the XZ plane of the frame of reference 412, in the camera frame of reference 312. The equation for the plane, as will be apparent to those skilled in the art, may state that the sum of (i) the X, Y, and Z coordinates of a point in the plane, multiplied by respective coefficients, with (ii) a constant parameter, is equal to zero. The above-mentioned coefficients of the plane equation are used to generate the Householder matrix.

Following block 625, in other words, the processor 500 can represent the positions of the markers 408 in the camera frame of reference 312. At block 630, the processor 500 is configured to determine a transform between the reflector frame of reference 412 and the chassis frame of reference 308. The transform determined at block 630 is a further matrix, “P”, defining a rotation and translation between the frames of reference 308 and 412.

Generation of the transform at block 630 can be performed as follows. For any given one of the chassis markers 316 detected in the image 800, the X, Y, and Z coordinates defining a 3D position of the marker 316 in the camera frame of reference 312 is given by:

$$( \begin{matrix}{x}_{j} \\ {y}_{j} \\ {z}_{j} \\ 1\end{matrix} ) = KHMP ( \begin{matrix}{X}_{j} \\ {Y}_{j} \\ {Z}_{j} \\ 1\end{matrix} )$$

where xⱼ, yⱼ, and zⱼ are the 3D coordinates of the marker 316 in the camera frame of reference 312, and Xⱼ, Yⱼ, and Zⱼ are the predefined 3D coordinates of the same marker 316 in the chassis frame of reference 308. The matrix “K” contains the camera intrinsic parameters mentioned above, such as a focal length and coordinates (e.g. in the frame of reference 312) of the center of the camera sensor. The matrix “H” is the reflective transformation determined from “M”, and therefore contains coefficients determined from the equation defining the plane of the reflective surface 404. For example, the coefficients of the matrix H may be products of selected coefficients of the planar equation. The matrix “M”, in turn, defines the transform between the reflector frame of reference 412 and the camera frame of reference 312, and the coefficients of the matrix M therefore include numerical values that, when applied as multipliers to specific coordinates from one frame of reference, produce coordinates in the other frame of reference. The matrix “P” is the transform between the frames of reference 308 and 412. The matrix P therefore defines numerical values that function as described in connection with the matrix M. The specific coefficients in the matrix P however, have not yet been determined.

As will now be apparent, aside from the matrix “P”, the remaining information in the above expression is known. Therefore, the processor 500 can solve for “P” by concatenating the four matrices K, H, M, and P, e.g. into a 4×4 matrix “A”, as follows:

$$A = ( \begin{matrix}{a}_{11} & {a}_{12} & {a}_{13} & {a}_{14} \\ {a}_{21} & {a}_{22} & {a}_{23} & {a}_{24} \\ {a}_{31} & {a}_{32} & {a}_{33} & {a}_{34} \\ 0 & 0 & 0 & 1\end{matrix} )$$

The processor 500 can then be configured to solve for the coefficients “a” of the matrix A by performing a direct linear transformation using the detected image positions of the markers 316 from the set 808, and the predetermined 3D positions of the markers 316 in the chassis frame of reference 308. For example, the processor 500 can be configured to solve the following system for the coefficients “a”:

$$( \begin{matrix}{X}_{0} & {Y}_{0} & {Z}_{0} & 1 & 0 & 0 & 0 & 0 & - {u}_{0} {X}_{0} & - {u}_{0} {Y}_{0} & - {u}_{0} {Z}_{0} & - 1 \\ 0 & 0 & 0 & 0 & {X}_{0} & {Y}_{0} & {Z}_{0} & 1 & {v}_{0} {X}_{0} & - {v}_{0} {Y}_{0} & - {u}_{0} {Z}_{0} & - 1 \\ {X}_{1} & {Y}_{1} & {Z}_{1} & 1 & 0 & 0 & 0 & 0 & - {u}_{1} {X}_{1} & - {u}_{1} {Y}_{1} & - {u}_{1} {Z}_{1} & - 1 \\ 0 & 0 & 0 & 1 & {X}_{1} & {Y}_{1} & {Z}_{1} & 1 & - {u}_{1} {X}_{1} & - {u}_{1} {Y}_{1} & - {u}_{1} {Z}_{1} & - 1 \\ … . & & & & & & & & & & & \\ {X}_{n} & {Y}_{n} & {Z}_{n} & 1 & 0 & 0 & 0 & 0 & - {u}_{n} {X}_{n} & - {u}_{n} {Y}_{n} & - {u}_{n} {Z}_{n} & - 1 \\ 0 & 0 & 0 & 0 & {X}_{n} & {Y}_{n} & {Z}_{n} & 1 & - {u}_{n} {X}_{n} & - {u}_{N} {Y}_{n} & - {u}_{n} {Z}_{n} & - 1\end{matrix} ) ( \begin{matrix}{a}_{11} \\ {a}_{12} \\ {a}_{13} \\ {a}_{14} \\ {a}_{21} \\ {a}_{22} \\ {a}_{23} \\ {a}_{24} \\ {a}_{31} \\ {a}_{32} \\ {a}_{33} \\ {a}_{34}\end{matrix} ) = 0$$

When the coefficients “a” have been solved, the matrix P can be determined from the matrix A and the matrices K, H, and M (which form three of the four inputs forming the matrix A). The processor 500, having determined the matrix P, has therefore completed determination of the transform between the reflector frame of reference 412 and the chassis frame of reference 308 at block 630.

At block 635, the processor 500 is configured to determine updated calibration data based on the transforms from blocks 625 and 630. In particular, the processor 500 is configured to determine a transform between the chassis frame of reference 308 and the camera frame of reference 312 by combining the transform M from block 625 with the transform P from block 630. The resulting transform between the chassis frame of reference 308 and the camera frame of reference 312 defines the extrinsic parameters of the camera 207 (e.g. the camera 207-4 in this example), defining the pose of the camera 207 relative to the chassis 300. The transform from block 635 is stored, e.g. in the memory 504, for subsequent use.

At block 640, the processor 500 determines whether any cameras 207 remain to be calibrated, and repeats the performance of blocks 615-635 for each remaining camera 207.

Variations to the above calibration mechanisms are contemplated. For example, in some implementations, the server 101 can perform at least a portion of the processing shown in FIG. 6, e.g. to reduce the computational and/or storage requirements imposed on the apparatus 103. For example, the server 101 can receive the image captured at block 620 from the apparatus, and perform the marker detection at block 620, as well as blocks 625, 630, and 635 before transmitting the resulting calibration data to the apparatus 103.

As will be understood from the discussion above, the system 100 provides certain technical improvements over other calibration systems. For example, the deployment of the markers and reflector discussed herein, which are detectable within data captured by certain sensors of the mobile automation apparatus 103, enables calibration of those sensors on-site, and without reliance on complex calibration structures distinct from the apparatus 103.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A calibration method for a mobile automation apparatus, the method comprising:
navigating the mobile automation apparatus to a calibration location containing a reflector;
controlling a camera of the mobile automation apparatus to capture an image depicting (i) a first set of markers affixed to the reflector in first predetermined positions defining a reflector frame of reference, and (ii) a second set of markers mounted on a chassis of the mobile automation apparatus in second predetermined positions defining a chassis frame of reference;
detecting respective image positions of each marker from the first set of markers and the second set of markers;
based on (i) the image positions of the first and second set of markers, (ii) the first predetermined positions, and (iii) the second predetermined positions, determining calibration parameters configured to convert between coordinates in a camera frame of reference and coordinates in the chassis frame of reference; and
updating calibration data of the camera with the calibration parameters.

2. The method of claim 1, wherein navigating the mobile automation apparatus to the calibration location includes:
receiving, at the mobile automation apparatus, a navigational command identifying the calibration location; and
controlling a locomotive assembly of the mobile automation apparatus to travel to the calibration location.

3. The method of claim 1, further comprising:
prior to controlling the camera to capture the image, determining whether the reflector is within a field of view of the camera; and
when the reflector is not within the field of view, repositioning the mobile automation apparatus.

4. The method of claim 1, wherein determining the calibration parameters includes:
based on the image positions of the first set of markers, and the first predetermined positions, determining a first set of parameters configured to convert between the reflector frame of reference and a camera frame of reference; and
determining a second set of parameters configured to convert between the reflector frame of reference and the chassis frame of reference.

5. The method of claim 4, further comprising combining the first set of parameters and the second set of parameters to generate the calibration parameters.

6. The method of claim 1, wherein the calibration data further includes camera intrinsic parameters.

7. The method of claim 1, further comprising:
repeating the controlling, detecting, determining, and updating for an additional camera of the mobile automation apparatus.

8. The method of claim 1, wherein detecting the first and second sets of markers includes distinguishing between markers of the first set and the second set based on a visual attribute of markers of the first and second set.

9. The method of claim 8, wherein the visual attribute includes at least one of shape and color.

10. A mobile automation apparatus, comprising:
a chassis;
a camera supported by the chassis;
a plurality of markers affixed to the chassis in predetermined positions defining a chassis frame of reference; and
a processor configured to:
responsive to arrival of the mobile automation apparatus at a calibration location containing a reflector, control the camera to capture an image depicting (i) a first set of markers affixed to the reflector in first predetermined positions defining a reflector frame of reference, and (ii) a subset of the markers affixed to the chassis;
detect respective image positions of each marker from the first set of markers and the second set of markers;
based on (i) the image positions of the first and second set of markers, (ii) the first predetermined positions, and (iii) the second predetermined positions, determine calibration parameters configured to convert between coordinates in a camera frame of reference and coordinates in the chassis frame of reference; and
update calibration data of the camera with the calibration parameters.

11. The mobile automation apparatus of claim 10, wherein the processor is further configured to:
receive a navigational command identifying the calibration location; and
control a locomotive assembly of the mobile automation apparatus to travel to the calibration location.

12. The mobile automation apparatus of claim 10, wherein the processor is further configured to:
prior to controlling the camera to capture the image, determine whether the reflector is within a field of view of the camera; and
when the reflector is not within the field of view, reposition the mobile automation apparatus.

13. The mobile automation apparatus of claim 10, wherein the processor is configured, to determine the calibration parameters, to:
based on the image positions of the first set of markers, and the first predetermined positions, determine a first set of parameters configured to convert between the reflector frame of reference and a camera frame of reference; and
determine a second set of parameters configured to convert between the reflector frame of reference and the chassis frame of reference.

14. The mobile automation apparatus of claim 13, wherein the processor is further configured to combine the first set of parameters and the second set of parameters to generate the calibration parameters.

15. The mobile automation apparatus of claim 10, wherein the calibration data further includes camera intrinsic parameters.

16. The mobile automation apparatus of claim 10, wherein the processor is further configured to:
repeat the controlling, detecting, determining, and updating for an additional camera of the mobile automation apparatus.

17. The mobile automation apparatus of claim 10, wherein the processor is further configured, to detect the first set of markers and the subset of markers, to distinguish between markers of the first set and the subset based on a visual attribute of markers of the first and second set.

18. The mobile automation apparatus of claim 17, wherein the visual attribute includes at least one of shape and color.

19. A non-transitory computer-readable medium storing computer-readable instructions for calibration of a mobile automation apparatus, the instructions executable by a processor to:
navigate the mobile automation apparatus to a calibration location containing a reflector;
control a camera of the mobile automation apparatus to capture an image depicting (i) a first set of markers affixed to the reflector in first predetermined positions defining a reflector frame of reference, and (ii) a second set of markers mounted on a chassis of the mobile automation apparatus in second predetermined positions defining a chassis frame of reference;
detect respective image positions of each marker from the first set of markers and the second set of markers;
based on (i) the image positions of the first and second set of markers, (ii) the first predetermined positions, and (iii) the second predetermined positions, determine calibration parameters configured to convert between coordinates in a camera frame of reference and coordinates in the chassis frame of reference; and
update calibration data of the camera with the calibration parameters.

20. The non-transitory computer-readable medium of claim 19, wherein the computer-readable instructions are further executable by the processor to determine the calibration parameters by:
based on the image positions of the first set of markers, and the first predetermined positions, determining a first set of parameters between the reflector frame of reference and a camera frame of reference; and
determining a second set of parameters between the reflector frame of reference and the chassis frame of reference.
